(19) United States
(12) Patent Application Publication
(10) Pub. No.: US 2017/0358266 A1
(43) Pub. Date: Dec. 14, 2017

(54) GOA CIRCUIT AND LIQUID CRYSTAL DISPLAY

(71) Applicant: Wuhan China Star Optoelectronics Technology Co., Ltd., Wuhan (CN)

(72) Inventors: Chunqian ZHANG, Wuhan (CN); Wang Chao, Wuhan (CN); Xue Jingfeng, Wuhan (CN); Li Yafeng, Wuhan (CN)

(21) Appl. No.: 15/318,358

(22) PCT Filed: Jul. 1, 2016
(86) PCT No.: PCT/CN2016/088152

§ 371 Date: Dec. 13, 2016

(30) Foreign Application Priority Data
Jun. 13, 2016 (CN) 201610421842.3

(51) Int. Cl. G09G 3/36

(52) U.S. Cl. CPC G09G 3/3677; G09G 2310/061; G09G 2310/0291; G09G 2300/0809

(57) ABSTRACT

A gate driver on array (GOA) circuit and a liquid crystal display include a plurality of stages of GOA unit circuits which are cascaded. Each stage of the GOA unit circuit includes a stage transmission signal buffering module which includes N inverters sequentially connected in series, where N is odd. At least one inverter comprises a first capacitor and a second capacitor. A first constant voltage is inputted into a terminal of the first capacitor, and a second constant voltage is inputted into a terminal of the second capacitor, and another terminal of the first capacitor and another terminal of the second capacitor are electrically connected with an output terminal of an (N−1)th inverter.

### FIELD OF THE INVENTION

The present invention relates to the field of liquid crystal displays, and more particularly to a gate driver on array (GOA) circuit and a liquid crystal display.

### BACKGROUND OF THE INVENTION

A gate driver on array (or gate on array) circuit, is manufactured by using an array process of an existing thin-film transistor display device (TFT-LCD), to fabricate a gate line scan drive signal circuit on an array substrate, so as to achieve a driving method where gate lines are scanned line by line. In comparing a conventional process of flexible printed circuit boards (COF) and glass printed circuit board (COG), manufacturing cost is saved, and a gate direction bonding process can be omitted, with advantages of increasing production capacity and improving integration of display devices.

In most existing GOA circuits, a stage transmission signal is used to directly switch-on a next stage GOA circuit. However, the stage transmission signal may jump or be influenced by an external interruption when it is transmitted stage by stage, thereby distorting an outputting stage transmission signal, such that charge of pixel electrodes will be influenced, and thus affecting spin of the liquid crystal and affecting light transmissivity of the panel.

### SUMMARY OF THE INVENTION

The present invention provides a GOA circuit, which can be used to solve the technical problem caused from the stage transmission signal may jump or be influenced by an external interruption when it is transmitted stage by stage, thereby distorting an outputting stage transmission signal, such that charge of pixel electrodes will be influenced, and thus affecting spin of the liquid crystal and affecting light transmissivity of the panel, in the prior art.

In order to solve the technical problem mentioned above, the present invention provides a GOA circuit, comprising: a plurality of stages of GOA unit circuits which are cascaded, each stage of the GOA unit circuit comprising: a stage transmission signal buffering module for outputting a present stage transmission signal and increasing a stability of the present stage transmission signal;

the stage transmission signal buffering module comprising N inverters sequentially connected in series, where N is odd, each of the inverters comprises a first thin film transistor and a second thin film transistor, a gate of the first thin film transistor and a gate of the second thin film transistor are electrically connected with an output terminal of an (N−1)th inverter, a first constant voltage is inputted into a source of the first thin film transistor, a second constant voltage is inputted into a source of the second thin film transistor, a drain of the first thin film transistor and a drain of the second thin film transistor are electrically connected with an input terminal of an (N+1)th inverter; the first thin film transistor is a P-type thin film transistor, and the second thin film transistor is an N-type thin film transistor; and

at least one inverter comprises a first capacitor and a second capacitor, where the first constant voltage is inputted into a terminal of the first capacitor, and the second constant voltage is inputted into a terminal of the second capacitor, and another terminal of the first capacitor and another terminal of the second capacitor are electrically connected with the output terminal of the (N−1)th inverter; the first constant voltage is at a constant high potential, and the second constant voltage is at a constant low potential.

The present stage transmission signal is inputted into an input terminal of a first inverter.

An output terminal of a last inverter is electrically connected with an input terminal of a next stage GOA unit circuit.

Each stage of the GOA unit circuit further comprises a positive and negative phase scan control module, a latching module, a reset module, and a signal processing module;

the positive and negative phase scan control module comprises two transmission gates; a previous stage transmission signal is inputted into an input terminal of a first transmission gate, a first control terminal is electrically connected with a first control unit, a second control terminal is electrically connected with a second control unit, an output terminal is electrically connected with an input terminal of the latching module; the previous stage transmission signal is inputted into an input terminal of a second transmission gate, a first control terminal is electrically connected with the second control unit, a second control terminal is electrically connected with the first control unit, an output terminal is electrically connected with the input terminal of the latching module;

the latching module comprises two clock control inverters and one of the inverter; a first terminal of a first clock control inverter is electrically connected with an output terminal of the positive and negative phase scan control module, a second terminal is electrically connected with an output terminal of the inverter on the latching module, a first clock signal is inputted into a control terminal, the output terminal is electrically connected with an input terminal of the inverter on the latching module; a second terminal of a second clock control inverter is electrically connected with the output terminal of the positive and negative phase scan control module, a first terminal is electrically connected with the output terminal of the inverter on the latching module, a second clock signal is inputted into a control terminal, the output terminal is electrically connected with the input terminal of the inverter on the latching module;

the reset module comprises a ninth thin film transistor, a reset signal is inputted into a gate of the ninth thin film transistor, a source is grounded, a drain is electrically connected with the input terminal of the inverter on the latching module; and

the signal processing module comprises a NAND gate controller, a first input terminal of the NAND gate controller is electrically connected with the output terminal of the inverter on the latching module, a third clock signal is inputted into a second input terminal, an output terminal is electrically connected with an input terminal of the stage transmission signal buffering module.

The transmission gate comprises a seventh thin film transistor and an eighth thin film transistor, a gate of the seventh thin film transistor is electrically connected with the first control terminal, a gate of the eighth thin film transistor is electrically connected with the second control terminal, a source of the seventh thin film transistor and a source of the eighth thin film transistor are electrically connected with the input terminal, a drain of the seventh thin film transistor and a drain of the eighth thin film transistor are electrically connected with the input terminal of the latching module.

The clock control inverter comprises a third thin film transistor, a fourth thin film transistor, a fifth thin film transistor, and a sixth thin film transistor;

a gate of the third thin film transistor is electrically connected with the first terminal, the constant high potential is inputted into a source, a drain is electrically connected with a source of the fourth thin film transistor;

a gate of the fourth thin film transistor and a gate of the fifth thin film transistor are electrically connected with the control terminal, a drain of the fourth thin film transistor and a drain of the fifth thin film transistor are electrically connected with an output terminal of the clock control inverter; a source of the fifth thin film transistor is electrically connected with a drain of the sixth thin film transistor;

a gate of the sixth thin film transistor is electrically connected with the second terminal, the constant low potential is inputted into a source.

The NAND gate controller comprises a tenth thin film transistor, an eleventh thin film transistor, a twelfth thin film transistor, and a thirteenth thin film transistor;

a gate of the tenth thin film transistor and a gate of the twelfth thin film transistor are electrically connected with the first input terminal, the constant high potential is inputted into a source of the tenth thin film transistor and a source of the eleventh thin film transistor, a drain of the tenth thin film transistor, a drain of the eleventh thin film transistor, and a drain of the twelfth thin film transistor are electrically connected with an output terminal of the NAND gate controller; a gate of the eleventh thin film transistor and a gate of the thirteenth thin film transistor are electrically connected with the second input terminal; a source of the twelfth thin film transistor is electrically connected with a drain of the thirteenth thin film transistor, the constant low potential is inputted into a source of the thirteenth thin film transistor.

The present invention also provides a GOA circuit, comprising: a plurality of stages of GOA unit circuits which are cascaded, each stage of the GOA unit circuit comprising: a stage transmission signal buffering module for outputting a present stage transmission signal and increasing a stability of the present stage transmission signal;

the stage transmission signal buffering module comprising N inverters sequentially connected in series, where N is odd, each of the inverters comprises a first thin film transistor and a second thin film transistor, a gate of the first thin film transistor and a gate of the second thin film transistor are electrically connected with an output terminal of an (N−1)th inverter, a first constant voltage is inputted into a source of the first thin film transistor, a second constant voltage is inputted into a source of the second thin film transistor, a drain of the first thin film transistor and a drain of the second thin film transistor are electrically connected with an input terminal of an (N+1)th inverter; and

at least one inverter comprises a first capacitor and a second capacitor, where the first constant voltage is inputted into a terminal of the first capacitor, and the second constant voltage is inputted into a terminal of the second capacitor, and another terminal of the first capacitor and another terminal of the second capacitor are electrically connected with the output terminal of the (N−1)th inverter.

The first constant voltage is at a constant high potential, and the second constant voltage is at a constant low potential.

The first thin film transistor is a P-type thin film transistor, and the second thin film transistor is an N-type thin film transistor.

The present stage transmission signal is inputted into an input terminal of a first inverter.

An output terminal of a last inverter is electrically connected with an input terminal of a next stage GOA unit circuit.

Each stage of the GOA unit circuit further comprises a positive and negative phase scan control module, a latching module, a reset module, and a signal processing module;

the positive and negative phase scan control module comprises two transmission gates; a previous stage transmission signal is inputted into an input terminal of a first transmission gate, a first control terminal is electrically connected with a first control unit, a second control terminal is electrically connected with a second control unit, an output terminal is electrically connected with an input terminal of the latching module; the previous stage transmission signal is inputted into an input terminal of a second transmission gate, a first control terminal is electrically connected with the second control unit, a second control terminal is electrically connected with the first control unit, an output terminal is electrically connected with the input terminal of the latching module;

the latching module comprises two clock control inverters and one of the inverter; a first terminal of a first clock control inverter is electrically connected with an output terminal of the positive and negative phase scan control module, a second terminal is electrically connected with an output terminal of the inverter on the latching module, a first clock signal is inputted into a control terminal, the output terminal is electrically connected with an input terminal of the inverter on the latching module; a second terminal of a second clock control inverter is electrically connected with the output terminal of the positive and negative phase scan control module, a first terminal is electrically connected with the output terminal of the inverter on the latching module, a second clock signal is inputted into a control terminal, the output terminal is electrically connected with the input terminal of the inverter on the latching module;

the reset module comprises a ninth thin film transistor, a reset signal is inputted into a gate of the ninth thin film transistor, a source is grounded, a drain is electrically connected with the input terminal of the inverter on the latching module; and

the signal processing module comprises a NAND gate controller, a first input terminal of the NAND gate controller is electrically connected with the output terminal of the inverter on the latching module, a third clock signal is inputted into a second input terminal, an output terminal is electrically connected with an input terminal of the stage transmission signal buffering module.

The transmission gate comprises a seventh thin film transistor and an eighth thin film transistor, a gate of the seventh thin film transistor is electrically connected with the first control terminal, a gate of the eighth thin film transistor is electrically connected with the second control terminal, a source of the seventh thin film transistor and a source of the eighth thin film transistor are electrically connected with the input terminal, a drain of the seventh thin film transistor and a drain of the eighth thin film transistor are electrically connected with the input terminal of the latching module.

The clock control inverter comprises a third thin film transistor, a fourth thin film transistor, a fifth thin film transistor, and a sixth thin film transistor;

a gate of the third thin film transistor is electrically connected with the first terminal, a constant high potential is inputted into a source, a drain is electrically connected with a source of the fourth thin film transistor;

a gate of the fourth thin film transistor and a gate of the fifth thin film transistor are electrically connected with the control terminal, a drain of the fourth thin film transistor and a drain of the fifth thin film transistor are electrically connected with an output terminal of the clock control inverter; a source of the fifth thin film transistor is electrically connected with a drain of the sixth thin film transistor;

a gate of the sixth thin film transistor is electrically connected with the second terminal, a constant low potential is inputted into a source.

The NAND gate controller comprises a tenth thin film transistor, an eleventh thin film transistor, a twelfth thin film transistor, and a thirteenth thin film transistor;

a gate of the tenth thin film transistor and a gate of the twelfth thin film transistor are electrically connected with the first input terminal, a constant high potential is inputted into a source of the tenth thin film transistor and a source of the eleventh thin film transistor, a drain of the tenth thin film transistor, a drain of the eleventh thin film transistor, and a drain of the twelfth thin film transistor are electrically connected with an output terminal of the NAND gate controller; a gate of the eleventh thin film transistor and a gate of the thirteenth thin film transistor are electrically connected with the second input terminal; a source of the twelfth thin film transistor is electrically connected with a drain of the thirteenth thin film transistor, a constant low potential is inputted into a source of the thirteenth thin film transistor.

According to the above object of the present invention, a liquid crystal display is provided, comprising: a GOA circuit which includes a plurality of stages of GOA unit circuits which are cascaded, each stage of the GOA unit circuit comprising: a stage transmission signal buffering module for outputting a present stage transmission signal and increasing a stability of the present stage transmission signal;

the stage transmission signal buffering module comprising N inverters sequentially connected in series, where N is odd, each of the inverters comprises a first thin film transistor and a second thin film transistor, a gate of the first thin film transistor and a gate of the second thin film transistor are electrically connected with an output terminal of an (N−1)th inverter, a first constant voltage is inputted into a source of the first thin film transistor, a second constant voltage is inputted into a source of the second thin film transistor, a drain of the first thin film transistor and a drain of the second thin film transistor are electrically connected with an input terminal of an (N+1)th inverter; and

at least one inverter comprises a first capacitor and a second capacitor, where the first constant voltage is inputted into a terminal of the first capacitor, and the second constant voltage is inputted into a terminal of the second capacitor, and another terminal of the first capacitor and another terminal of the second capacitor are electrically connected with the output terminal of the (N−1)th inverter.

The first constant voltage is at a constant high potential, and the second constant voltage is at a constant low potential.

The first thin film transistor is a P-type thin film transistor, and the second thin film transistor is an N-type thin film transistor.

Each stage of the GOA unit circuit further comprises a positive and negative phase scan control module, a latching module, a reset module, and a signal processing module;

the positive and negative phase scan control module comprises two transmission gates; a previous stage transmission signal is inputted into an input terminal of a first transmission gate, a first control terminal is electrically connected with a first control unit, a second control terminal is electrically connected with a second control unit, an output terminal is electrically connected with an input terminal of the latching module; the previous stage transmission signal is inputted into an input terminal of a second transmission gate, a first control terminal is electrically connected with the second control unit, a second control terminal is electrically connected with the first control unit, an output terminal is electrically connected with the input terminal of the latching module;

the latching module comprises two clock control inverters and one of the inverter; a first terminal of a first clock control inverter is electrically connected with an output terminal of the positive and negative phase scan control module, a second terminal is electrically connected with an output terminal of the inverter on the latching module, a first clock signal is inputted into a control terminal, the output terminal is electrically connected with an input terminal of the inverter on the latching module; a second terminal of a second clock control inverter is electrically connected with the output terminal of the positive and negative phase scan control module, a first terminal is electrically connected with the output terminal of the inverter on the latching module, a second clock signal is inputted into a control terminal, the output terminal is electrically connected with the input terminal of the inverter on the latching module;

the reset module comprises a ninth thin film transistor, a reset signal is inputted into a gate of the ninth thin film transistor, a source is grounded, a drain is electrically connected with the input terminal of the inverter on the latching module; and

the signal processing module comprises a NAND gate controller, a first input terminal of the NAND gate controller is electrically connected with the output terminal of the inverter on the latching module, a third clock signal is inputted into a second input terminal, an output terminal is electrically connected with an input terminal of the stage transmission signal buffering module.

In the GOA circuit and the liquid crystal display of the present invention, the first capacitor and the second capacitor are disposed on at least one inverter of the N inverters to filter the stage transmission signal, so as to prevent the stage transmission signal being distorted due to power jumping or an external interruption, thereby achieving that the stage transmission signal is stably outputted and charge of pixel electrodes is preferably controlled, and thus spin of the liquid crystal and light transmissivity of the panel will not be affected.

### BRIEF DESCRIPTION OF THE DRAWINGS

The technical solution, as well as beneficial advantages, of the present invention will be apparent from the following detailed description embodiments of the present invention, with reference to the attached drawings.

FIG. 1 is a circuit diagram of an embodiment of a GOA circuit of the present invention.

FIG. 2 is a specific circuit structure diagram of an inverter.

FIG. 3 is a specific circuit structure diagram of a transmission gate.

FIG. 4 is a specific circuit structure diagram of a clock control inverter.

FIG. 5 is a specific circuit structure diagram of a NAND gate controller.

FIG. 6 is a first stage GOA unit circuit diagram of the embodiment of the GOA circuit of the present invention.

FIG. 7 is the last stage GOA unit circuit diagram of the embodiment of the GOA circuit of the present invention.

FIG. 8 is a timing diagram illustrating operation of the embodiment of the GOA circuit of the present invention.

### DETAILED DESCRIPTION OF THE INVENTION

In order to further elaborate the manner and the results achieved by the present invention, detailed description of preferred embodiments will be given along with the accompanied drawings.

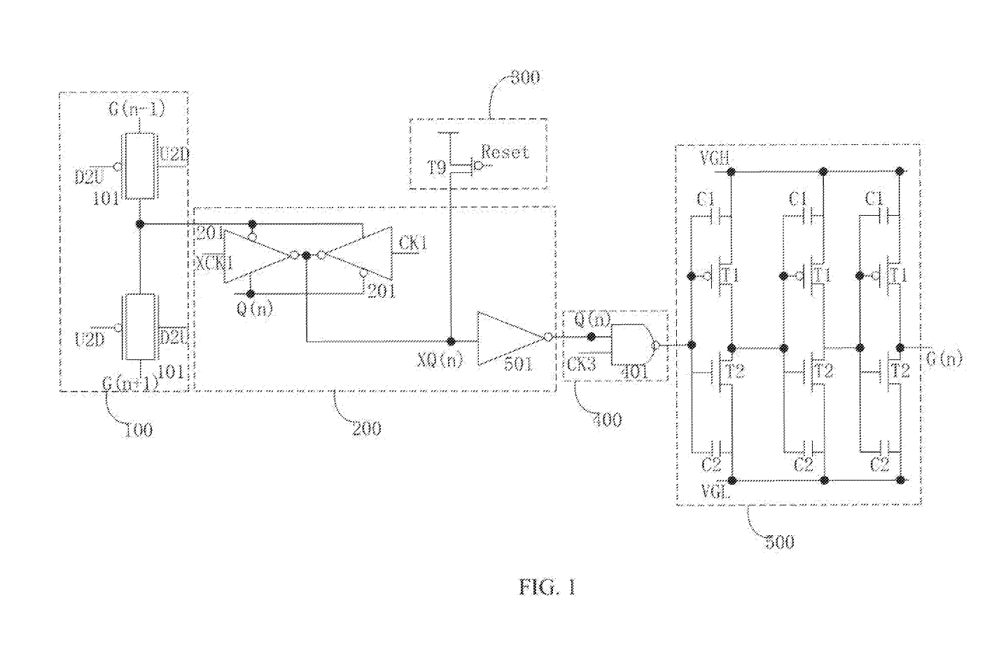

In FIG. 1, which is a circuit diagram of an embodiment of a GOA circuit of the present invention.

The GOA circuit of the present invention comprises a plurality of cascaded GOA unit circuit stages. Each stage of the GOA unit circuit comprises a stage transmission signal buffering module 500 for outputting a present stage transmission signal and increasing stability of a present stage transmission signal.

The stage transmission signal buffering module 500 comprises N inverters 501 sequentially connected in series, where N is odd. Preferably, in this embodiment, the stage transmission signal buffering module 500 comprises three inverters 501 sequentially connected in series. It should be understood that the amount of the inverters is not limited to being three, if space permits, it could be any odd number.

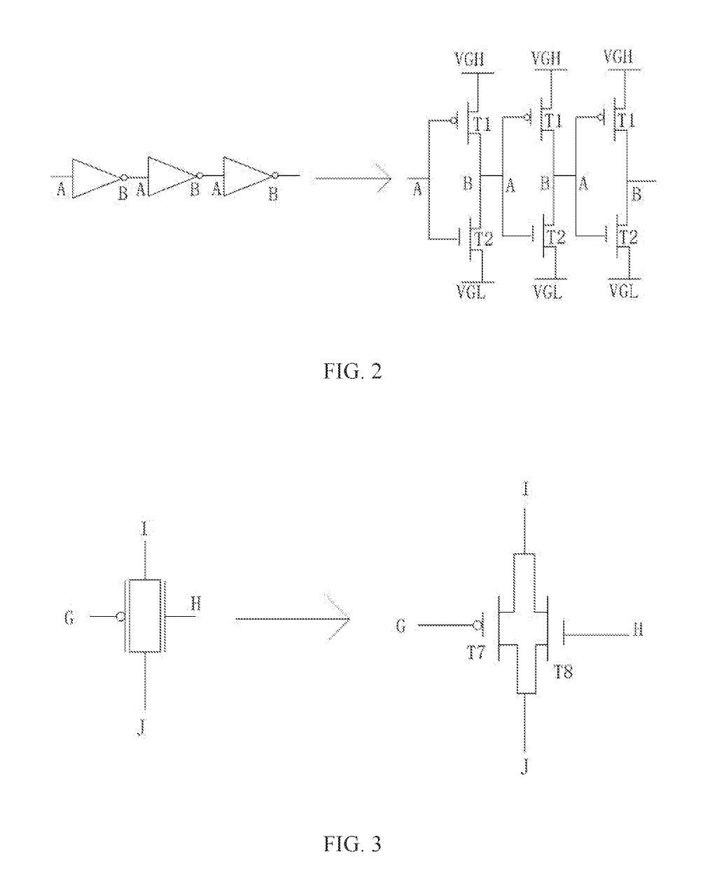

As shown in FIG. 2, the inverter 501 comprises a first thin film transistor T1 and a second thin film transistor T2. A gate of the first thin film transistor T1 and a gate of the second thin film transistor T2 are electrically connected with an output terminal of a previous inverter 501. A first constant voltage is inputted into a source of the first thin film transistor T1. A second constant voltage is inputted into a source of the second thin film transistor T2. A drain of the first thin film transistor T1 and a drain of the second thin film transistor T2 are electrically connected with an input terminal A of a next inverter.

At least one inverter 501 comprises a first capacitor C1 and a second capacitor C2. Preferably, in this embodiment, each inverter 501 of the stage transmission signal buffering module 500 comprises the first capacitor C1 and the second capacitor C2. It should be noted that it is not necessary to dispose the first capacitor C1 and the second capacitor C2 in each inverter, if space does not permit. The first capacitor C1 and the second capacitor C2 could be disposed in only one of the inverters 501.

The first constant voltage is inputted into a terminal of the first capacitor C1. The second constant voltage is inputted into a terminal of the second capacitor C2. Another terminal of the first capacitor C1 and another terminal of the second capacitor C2 are electrically connected with the output terminal B of the previous inverter 501.

The first constant voltage is at a constant high potential VGH, and the second constant voltage is at a constant low potential VGL.

The first thin film transistor T1 is a P-type thin film transistor, and the second thin film transistor T2 is an N-type thin film transistor.

The present stage transmission signal is inputted into an input terminal A of a first inverter 501 of the three inverters 501 connected in series. An output terminal B is electrically connected with an input terminal A of the second inverter 501.

An output terminal of the last inverter 501 of the three inverters 501 connected in series is electrically connected with an input terminal of a next stage GOA unit circuit.

Each stage of the GOA unit circuit further comprises a positive and negative phase scan control module 100, a latching module 200, a reset module 300, and a signal processing module 400.

In FIG. 1 and FIG. 3, the positive and negative phase scan control module 100 comprises two transmission gates. A previous stage transmission signal G(n−1) is inputted into an input terminal I of a first transmission gate 101. A first control terminal G is electrically connected with a first control unit D2U. A second control terminal H is electrically connected with a second control unit U2D. An output terminal J is electrically connected with an input terminal of the latching module 200. The previous stage transmission signal G(n+1) is inputted into an input terminal I of a second transmission gate 101. A first control terminal G is electrically connected with the second control unit U2D. A second control terminal H is electrically connected with the first control unit D2U. An output terminal J is electrically connected with the input terminal of the latching module 200.

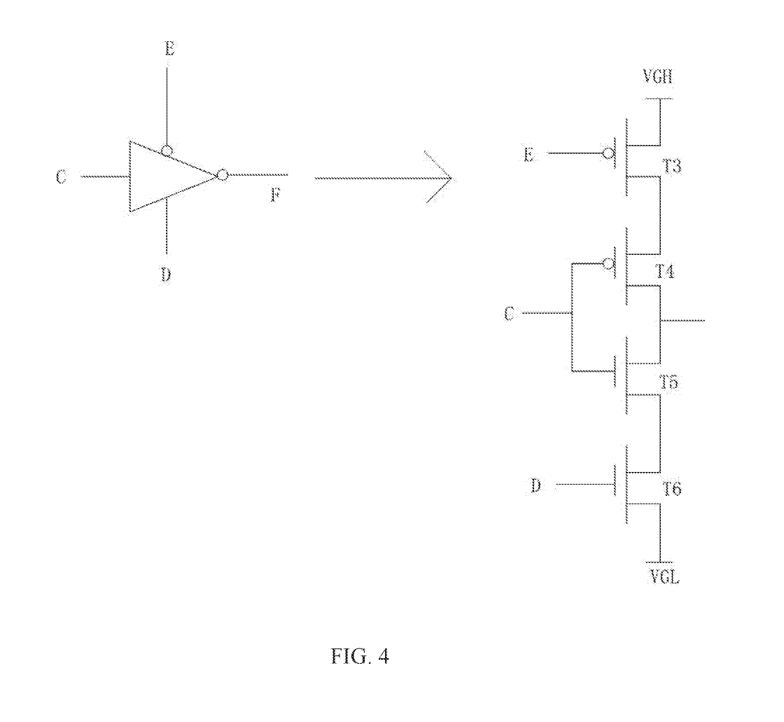

In FIG. 1 and FIG. 4, the latching module 200 comprises two clock control inverters 201 and one of the inverter 501. A first terminal E of a first clock control inverter 201 is electrically connected with an output terminal of the positive and negative phase scan control module 100. A second terminal D is electrically connected with an output terminal B of the inverter 501 which is located on the latching module 200. A first clock signal XCK1 is inputted into a control terminal C. The output terminal F is electrically connected with an input terminal A of the inverter 501 which is located on the latching module 200. A second terminal D of a second clock control inverter 201 is electrically connected with the output terminal of the positive and a negative phase scan control module 100. A first terminal E is electrically connected with the output terminal B of the inverter 501 which is located on the latching module 200. A second clock signal CK1 is inputted into a control terminal C. The output terminal F is electrically connected with the input terminal A of the inverter 501 which is located on the latching module 200.

A phase of the first clock signal XCK1 is opposite to a phase of the second clock signal CK1.

The reset module 300 comprises a ninth thin film transistor T9. A reset signal (Reset) is inputted into a gate of the ninth thin film transistor T9. A source is grounded. A drain is electrically connected with the input terminal A of the inverter 501 which is located on the latching module 200.

Before a start of a regular operation of the GOA circuit of the present invention, a potential of the stage transmission signal should be reset to zero. Specifically, the ninth thin film transistor T9 is a P-type thin film transistor. When the reset signal (Reset) is at a low potential, the ninth thin film transistor T9 is switched on, and the output terminal F of the clock control inverter 201 is reset to zero.

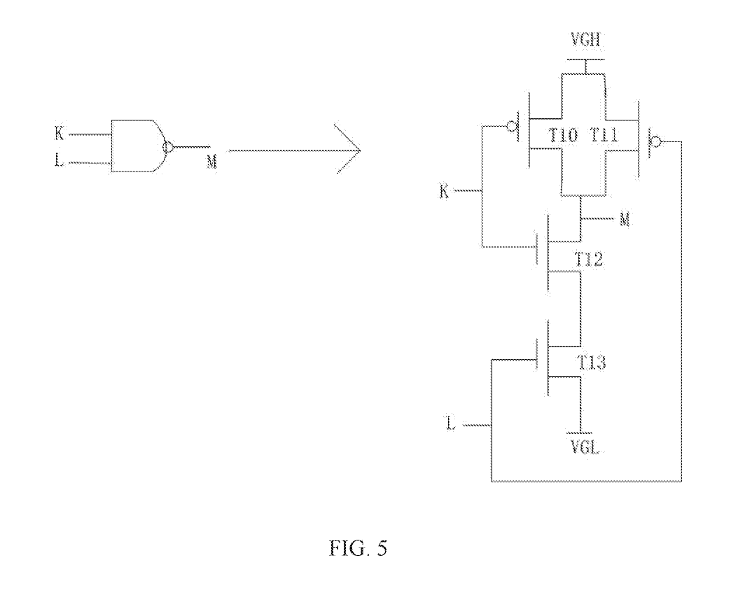

In FIG. 1 and FIG. 5, the signal processing module 400 comprises a NAND gate controller 401. A first input terminal K of the NAND gate controller 401 is electrically connected with the output terminal B of the inverter 501 which is located on the latching module 200. A third clock signal CK3 is inputted into a second input terminal L. An output terminal M is electrically connected with an input terminal of the stage transmission signal buffering module 500.

As shown in FIG. 3, the transmission gate 101 comprises a seventh thin film transistor T7 and an eighth thin film transistor T8. A gate of the seventh thin film transistor T7 is electrically connected with the first control terminal G. A gate of the eighth thin film transistor T8 is electrically connected with the second control terminal H. A source of the seventh thin film transistor T7 and a source of the eighth thin film transistor T8 are electrically connected with the input terminal I. A gate of the eighth thin film transistor T8 is electrically connected with the second control terminal H. A drain of the seventh thin film transistor T7 and a drain of the eighth thin film transistor T8 are electrically connected with the output terminal J.

The seventh thin film transistor is a P-type thin film transistor, and the eighth thin film transistor is an N-type thin film transistor.

As shown on FIG. 4, the clock control inverter 201 comprises a third thin film transistor T3, a fourth thin film transistor T4, a fifth thin film transistor T5, and a sixth thin film transistor T6.

A gate of the third thin film transistor T3 is electrically connected with the first terminal E. The constant high potential is inputted into a source. A drain is electrically connected with a source of the fourth thin film transistor T4.

A gate of the fourth thin film transistor T4 and a gate of the fifth thin film transistor T5 are electrically connected with the control terminal C. A drain of the fourth thin film transistor T4 and a drain of the fifth thin film transistor T5 are electrically connected with the output terminal F. A source of the fifth thin film transistor T5 is electrically connected with a drain of the sixth thin film transistor T6.

A gate of the sixth thin film transistor T6 is electrically connected with the second terminal D. The constant low potential is inputted into a source.

The third thin film transistor and the fourth thin film transistor are P-type thin film transistors, and the fifth thin film transistor and the sixth thin film transistor are N-type thin film transistors.

As shown on FIG. 5, the NAND gate controller 401 comprises a tenth thin film transistor T10, an eleventh thin film transistor T11, a twelfth thin film transistor T12, and a thirteenth thin film transistor T13.

A gate of the tenth thin film transistor T10 and a gate of the twelfth thin film transistor T12 are electrically connected with the first input terminal K. The constant high potential is inputted into a source of the tenth thin film transistor T10 and a source of the eleventh thin film transistor T11. A drain of the tenth thin film transistor T10, a drain of the eleventh thin film transistor T11, and a drain of the twelfth thin film transistor T12 are electrically connected with the output terminal M. A gate of the eleventh thin film transistor T11 and a gate of the thirteenth thin film transistor T13 are electrically connected with the second input terminal L. A source of the twelfth thin film transistor T12 is electrically connected with a drain of the thirteenth thin film transistor T13. The constant low potential is inputted into a source of the thirteenth thin film transistor T13.

The tenth thin film transistor and the eleventh thin film transistor are P-type thin film transistors. The twelfth thin film transistor and the thirteenth thin film transistor are N-type thin film transistors.

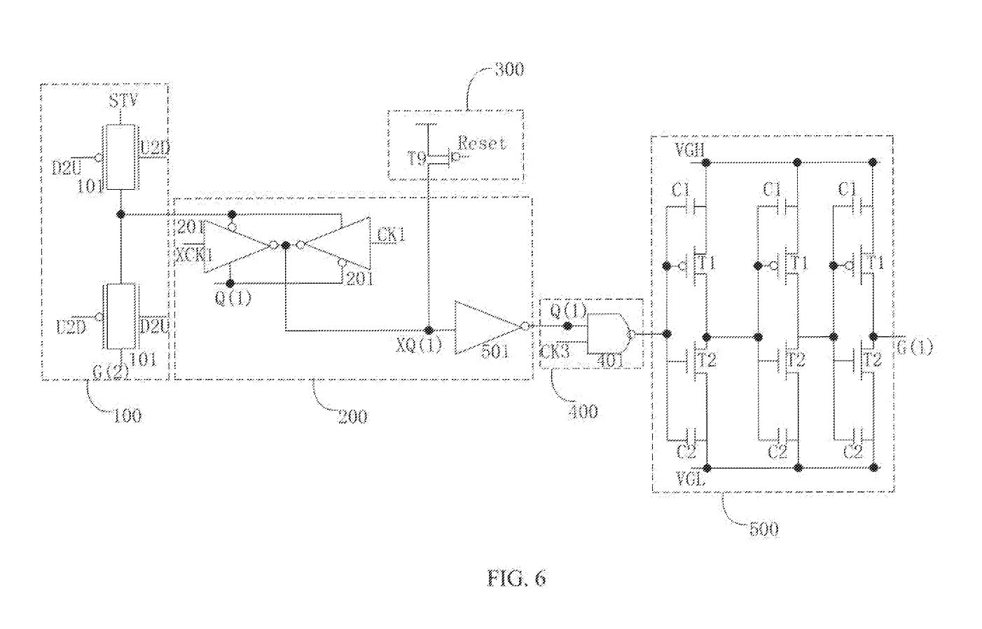

Specifically, in FIG. 6, in the first stage GOA unit circuit, a start signal STV of the circuit is inputted into the input terminal I of the first transmission gate 101.

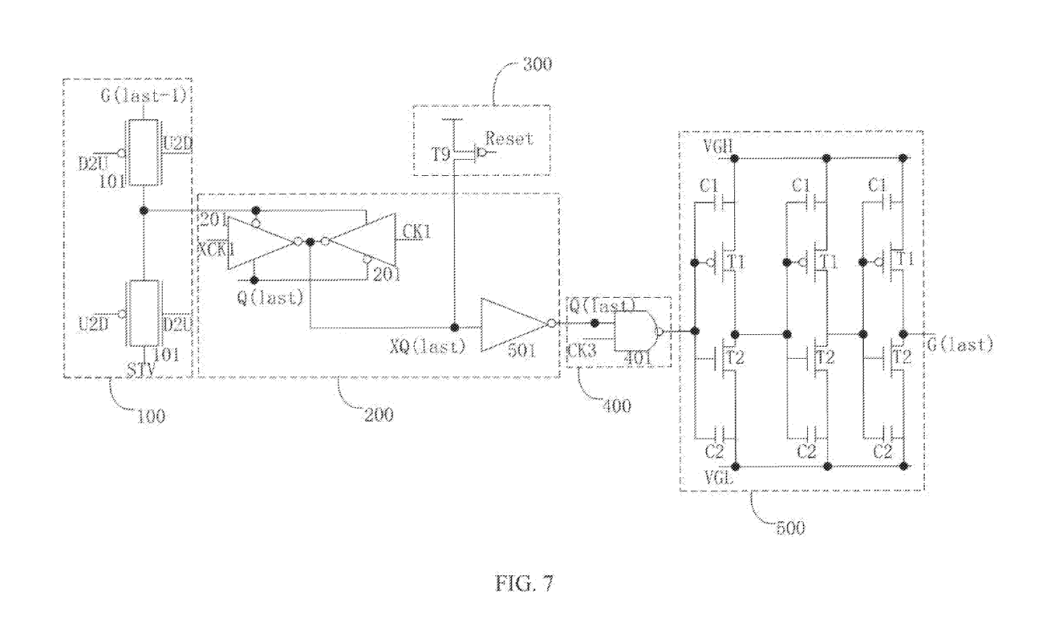

In FIG. 7, in the last stage GOA unit circuit, the start signal STV of the circuit is inputted into the input terminal I of the second transmission gate 101.

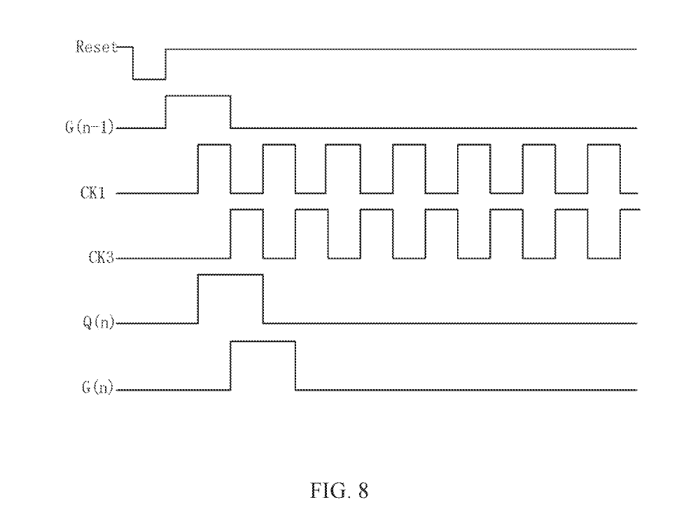

In FIG. 8, the embodiment of the GOA circuit of the present invention is employed in a dual direction driving GOA circuit. Explanation is made taking the forward scan as an example. The operation processes comprises the first stage GOA circuit is switched on via the start signal STV of the circuit, and a scan driving operation is processed sequentially stage by stage. When the scan driving operation goes to an N stage GOA unit circuit, the first control unit D2U is at a low potential, and the second control unit U2D is at a high potential, thereby the stage transmission signal G(n−1) is transmitted to the input terminal of the latching module 200.

When the stage transmission signal G(n−1) is transmitted to the input terminal of the latching module 200 and the stage transmission signal is at the high potential and the first clock signal XCK1 is at the low potential, the second clock signal CK1 will be at the high potential. The output terminal F of the clock control inverter 201 outputs an inverted-phase stage transmission signal XQ(n) with the low potential, and then it will be inverted by the inverter 501 to obtain a stage transmission signal Q(n) with the high potential. When the first clock signal XCK1 is at the high potential and the second clock signal CK1 is at the low potential, the output terminal F of the clock control inverter 201 outputs the inverted-phase stage transmission signal XQ(n) with the low potential, and then it will be inverted by the inverter 501 to obtain the stage transmission signal Q(n) with the high potential. Thus, the latch operation of the stage transmission signal Q(n) is achieved.

Furthermore, when the stage transmission signal G(n−1) is transmitted to the input terminal of the latching module 200 and the stage transmission signal is at the low potential and the first clock signal XCK1 is at the low potential, the second clock signal CK1 will be at the high potential. The output terminal F of the clock control inverter 201 will output the inverted-phase stage transmission signal XQ(n) with the high potential, and then it will be inverted by the inverter 501 to obtain the stage transmission signal Q(n) with the low potential. When the first clock signal XCK1 is at the high potential and the second clock signal CK1 is at the low potential, the output terminal F of the clock control inverter 201 will output the inverted-phase stage transmission signal XQ(n) with the high potential, and then it will be inverted by the inverter 501 to obtain the stage transmission signal Q(n) with the low potential. Thus, the latch operation of the stage transmission signal Q(n) is achieved.

When the stage transmission signal Q(n) is transmitted to an input terminal of the signal processing module 400, the stage transmission signal is at the high potential, and the third clock signal CK3 is at the high potential, and the first input terminal K of the NAND gate controller 401 is at the high potential, and the second input terminal L is at the high potential, and the output terminal M is at the low potential. After it is inverted by the three inverters 501, the stage transmission signal is at the high potential. When the third clock signal CK3 is at the low potential, the output terminal of the NAND gate controller 401 is at the high potential. After it is inverted by the three inverters 501, the stage transmission signal is at the low potential.

Furthermore, when the stage transmission signal is transmitted to the input terminal of the signal processing module 400, the stage transmission signal is at the low potential, and the third clock signal CK3 is at the high potential, and the first input terminal K of the NAND gate controller 401 is at the low potential, and the second input terminal L is at the high potential, and the output terminal M is at the low potential. After it is inverted by odd inverter(s) 501, the stage transmission signal is at the low potential. When the third clock signal CK3 is at the low potential, the output terminal of the NAND gate controller 401 is at the high potential. After it is inverted by odd inverter(s) 501, the stage transmission signal is at the low potential.

Specifically, the three inverters 501 comprise the first capacitor C1 and the second capacitor C2. The stage transmission signal outputted by the signal processing module 400 is filtered by the capacitors, so that the stage transmission signal outputted by the stage transmission signal buffering module will be more stable.

In the GOA circuit and the liquid crystal display of the present invention, the first capacitor and the second capacitor are disposed on at least one inverter of the odd inverter(s) to filter the stage transmission signal, so as to prevent the stage transmission signal being distorted due to power jumping or an external interruption, thereby achieving that the stable output and charge of pixel electrodes being preferably controlled, and thus spin of the liquid crystal and light transmissivity of the panel will not be affected.

The above-described embodiments are only preferred embodiments of the present application. It should be noted that, for the person skilled in the art, many modifications and improvements may be made to the present application without departing from the principle of the present application, and these modifications and improvements are also deemed to fall into the protection scope of the present application.

What is claimed is:

1. A gate driver on array (GOA) circuit, comprising: a plurality of stages of GOA unit circuits which are cascaded, each stage of the GOA unit circuit comprising: a stage transmission signal buffering module for outputting a present stage transmission signal and increasing a stability of the present stage transmission signal;
the stage transmission signal buffering module comprising N inverters sequentially connected in series, wherein N is odd, each of the inverters comprises a first thin film transistor and a second thin film transistor, a gate of the first thin film transistor and a gate of the second thin film transistor are electrically connected with an output terminal of an (N−1)th inverter, a first constant voltage is inputted into a source of the first thin film transistor, a second constant voltage is inputted into a source of the second thin film transistor, a drain of the first thin film transistor and a drain of the second thin film transistor are electrically connected with an input terminal of an (N+1)th inverter; the first thin film transistor is a P-type thin film transistor, and the second thin film transistor is an N-type thin film transistor; and
at least one inverter comprising a first capacitor and a second capacitor, wherein the first constant voltage is inputted into a terminal of the first capacitor, and the second constant voltage is inputted into a terminal of the second capacitor, and another terminal of the first capacitor and another terminal of the second capacitor are electrically connected with the output terminal of the (N−1)th inverter; the first constant voltage is at a constant high potential, and the second constant voltage is at a constant low potential.

2. The GOA circuit as claimed in claim 1, wherein the present stage transmission signal is inputted into an input terminal of a first inverter.

3. The GOA circuit as claimed in claim 1, wherein an output terminal of a last inverter is electrically connected with an input terminal of a next stage GOA unit circuit.

4. The GOA circuit as claimed in claim 1, wherein each stage of the GOA unit circuit further comprises a positive and negative phase scan control module, a latching module, a reset module, and a signal processing module;
the positive and negative phase scan control module comprises two transmission gates; a previous stage transmission signal is inputted into an input terminal of a first transmission gate, a first control terminal is electrically connected with a first control unit, a second control terminal is electrically connected with a second control unit, an output terminal is electrically connected with an input terminal of the latching module; the previous stage transmission signal is inputted into an input terminal of a second transmission gate, a first control terminal is electrically connected with the second control unit, a second control terminal is electrically connected with the first control unit, an output terminal is electrically connected with the input terminal of the latching module;
the latching module comprises two clock control inverters and one of the inverter; a first terminal of a first clock control inverter is electrically connected with an output terminal of the positive and negative phase scan control module, a second terminal is electrically connected with an output terminal of the inverter on the latching module, a first clock signal is inputted into a control terminal, the output terminal is electrically connected with an input terminal of the inverter on the latching module; a second terminal of a second clock control inverter is electrically connected with the output terminal of the positive and negative phase scan control module, a first terminal is electrically connected with the output terminal of the inverter on the latching module, a second clock signal is inputted into a control terminal, the output terminal is electrically connected with the input terminal of the inverter on the latching module;
the reset module comprises a ninth thin film transistor, a reset signal is inputted into a gate of the ninth thin film transistor, a source is grounded, a drain is electrically connected with the input terminal of the inverter on the latching module; and
the signal processing module comprises a NAND gate controller, a first input terminal of the NAND gate controller is electrically connected with the output terminal of the inverter on the latching module, a third clock signal is inputted into a second input terminal, an output terminal is electrically connected with an input terminal of the stage transmission signal buffering module.

5. The GOA circuit as claimed in claim 4, wherein the transmission gate comprises a seventh thin film transistor and an eighth thin film transistor, a gate of the seventh thin film transistor is electrically connected with the first control terminal, a gate of the eighth thin film transistor is electrically connected with the second control terminal, a source of the seventh thin film transistor and a source of the eighth thin film transistor are electrically connected with the input terminal, a drain of the seventh thin film transistor and a drain of the eighth thin film transistor are electrically connected with the input terminal of the latching module.

6. The GOA circuit as claimed in claim 4, wherein the clock control inverter comprises a third thin film transistor, a fourth thin film transistor, a fifth thin film transistor, and a sixth thin film transistor;
a gate of the third thin film transistor is electrically connected with the first terminal, the constant high potential is inputted into a source, a drain is electrically connected with a source of the fourth thin film transistor;
a gate of the fourth thin film transistor and a gate of the fifth thin film transistor are electrically connected with the control terminal, a drain of the fourth thin film transistor and a drain of the fifth thin film transistor are electrically connected with an output terminal of the clock control inverter; a source of the fifth thin film transistor is electrically connected with a drain of the sixth thin film transistor;
a gate of the sixth thin film transistor is electrically connected with the second terminal, the constant low potential is inputted into a source.

7. The GOA circuit as claimed in claim 4, wherein the NAND gate controller comprises a tenth thin film transistor, an eleventh thin film transistor, a twelfth thin film transistor, and a thirteenth thin film transistor;
a gate of the tenth thin film transistor and a gate of the twelfth thin film transistor are electrically connected with the first input terminal, the constant high potential is inputted into a source of the tenth thin film transistor and a source of the eleventh thin film transistor, a drain of the tenth thin film transistor, a drain of the eleventh thin film transistor, and a drain of the twelfth thin film transistor are electrically connected with an output terminal of the NAND gate controller; a gate of the eleventh thin film transistor and a gate of the thirteenth thin film transistor are electrically connected with the second input terminal; a source of the twelfth thin film transistor is electrically connected with a drain of the thirteenth thin film transistor, the constant low potential is inputted into a source of the thirteenth thin film transistor.

8. A GOA circuit, comprising: a plurality of stages of GOA unit circuits which are cascaded, each stage of the GOA unit circuit comprising: a stage transmission signal buffering module for outputting a present stage transmission signal and increasing a stability of the present stage transmission signal;
the stage transmission signal buffering module comprising N inverters sequentially connected in series, wherein N is odd, each of the inverters comprises a first thin film transistor and a second thin film transistor, a gate of the first thin film transistor and a gate of the second thin film transistor are electrically connected with an output terminal of an (N−1)th inverter, a first constant voltage is inputted into a source of the first thin film transistor, a second constant voltage is inputted into a source of the second thin film transistor, a drain of the first thin film transistor and a drain of the second thin film transistor are electrically connected with an input terminal of an (N+1)th inverter; and
at least one inverter comprising a first capacitor and a second capacitor, wherein the first constant voltage is inputted into a terminal of the first capacitor, and the second constant voltage is inputted into a terminal of the second capacitor, and another terminal of the first capacitor and another terminal of the second capacitor are electrically connected with the output terminal of the (N−1)th inverter.

9. The GOA circuit as claimed in claim 8, wherein the first constant voltage is at a constant high potential, and the second constant voltage is at a constant low potential.

10. The GOA circuit as claimed in claim 8, wherein the first thin film transistor is a P-type thin film transistor, and the second thin film transistor is an N-type thin film transistor.

11. The GOA circuit as claimed in claim 8, wherein the present stage transmission signal is inputted into an input terminal of a first inverter.

12. The GOA circuit as claimed in claim 8, wherein an output terminal of a last inverter is electrically connected with an input terminal of a next stage GOA unit circuit.

13. The GOA circuit as claimed in claim 8, wherein each stage of the GOA unit circuit further comprises a positive and negative phase scan control module, a latching module, a reset module, and a signal processing module;
the positive and negative phase scan control module comprises two transmission gates; a previous stage transmission signal is inputted into an input terminal of a first transmission gate, a first control terminal is electrically connected with a first control unit, a second control terminal is electrically connected with a second control unit, an output terminal is electrically connected with an input terminal of the latching module; the previous stage transmission signal is inputted into an input terminal of a second transmission gate, a first control terminal is electrically connected with the second control unit, a second control terminal is electrically connected with the first control unit, an output terminal is electrically connected with the input terminal of the latching module;
the latching module comprises two clock control inverters and one of the inverter; a first terminal of a first clock control inverter is electrically connected with an output terminal of the positive and negative phase scan control module, a second terminal is electrically connected with an output terminal of the inverter on the latching module, a first clock signal is inputted into a control terminal, the output terminal is electrically connected with an input terminal of the inverter on the latching module; a second terminal of a second clock control inverter is electrically connected with the output terminal of the positive and negative phase scan control module, a first terminal is electrically connected with the output terminal of the inverter on the latching module, a second clock signal is inputted into a control terminal, the output terminal is electrically connected with the input terminal of the inverter on the latching module;
the reset module comprises a ninth thin film transistor, a reset signal is inputted into a gate of the ninth thin film transistor, a source is grounded, a drain is electrically connected with the input terminal of the inverter on the latching module; and
the signal processing module comprises a NAND gate controller, a first input terminal of the NAND gate controller is electrically connected with the output terminal of the inverter on the latching module, a third clock signal is inputted into a second input terminal, an output terminal is electrically connected with an input terminal of the stage transmission signal buffering module.

14. The GOA circuit as claimed in claim 13, wherein the transmission gate comprises a seventh thin film transistor and an eighth thin film transistor, a gate of the seventh thin film transistor is electrically connected with the first control terminal, a gate of the eighth thin film transistor is electrically connected with the second control terminal, a source of the seventh thin film transistor and a source of the eighth thin film transistor are electrically connected with the input terminal, a drain of the seventh thin film transistor and a drain of the eighth thin film transistor are electrically connected with the input terminal of the latching module.

15. The GOA circuit as claimed in claim 13, wherein the clock control inverter comprises a third thin film transistor, a fourth thin film transistor, a fifth thin film transistor, and a sixth thin film transistor;
a gate of the third thin film transistor is electrically connected with the first terminal, a constant high potential is inputted into a source, a drain is electrically connected with a source of the fourth thin film transistor;
a gate of the fourth thin film transistor and a gate of the fifth thin film transistor are electrically connected with the control terminal, a drain of the fourth thin film transistor and a drain of the fifth thin film transistor are electrically connected with an output terminal of the clock control inverter; a source of the fifth thin film transistor is electrically connected with a drain of the sixth thin film transistor;
a gate of the sixth thin film transistor is electrically connected with the second terminal, a constant low potential is inputted into a source.

16. The GOA circuit as claimed in claim 13, wherein the NAND gate controller comprises a tenth thin film transistor, an eleventh thin film transistor, a twelfth thin film transistor, and a thirteenth thin film transistor;
a gate of the tenth thin film transistor and a gate of the twelfth thin film transistor are electrically connected with the first input terminal, a constant high potential is inputted into a source of the tenth thin film transistor and a source of the eleventh thin film transistor, a drain of the tenth thin film transistor, a drain of the eleventh thin film transistor, and a drain of the twelfth thin film transistor are electrically connected with an output terminal of the NAND gate controller; a gate of the eleventh thin film transistor and a gate of the thirteenth thin film transistor are electrically connected with the second input terminal; a source of the twelfth thin film transistor is electrically connected with a drain of the thirteenth thin film transistor, a constant low potential is inputted into a source of the thirteenth thin film transistor.

17. A liquid crystal display, comprising: a GOA circuit which includes a plurality of stages of GOA unit circuits which are cascaded, each stage of the GOA unit circuit comprising: a stage transmission signal buffering module for outputting a present stage transmission signal and increasing a stability of the present stage transmission signal;
the stage transmission signal buffering module comprising N inverters sequentially connected in series, wherein N is odd, each of the inverters comprises a first thin film transistor and a second thin film transistor, a gate of the first thin film transistor and a gate of the second thin film transistor are electrically connected with an output terminal of an (N−1)th inverter, a first constant voltage is inputted into a source of the first thin film transistor, a second constant voltage is inputted into a source of the second thin film transistor, a drain of the first thin film transistor and a drain of the second thin film transistor are electrically connected with an input terminal of an (N+1)th inverter; and
at least one inverter comprising a first capacitor and a second capacitor, wherein the first constant voltage is inputted into a terminal of the first capacitor, and the second constant voltage is inputted into a terminal of the second capacitor, and another terminal of the first capacitor and another terminal of the second capacitor are electrically connected with the output terminal of the (N−1)th inverter.

18. The liquid crystal display as claimed in claim 17, wherein the first constant voltage is at a constant high potential, and the second constant voltage is at a constant low potential.

19. The liquid crystal display as claimed in claim 17, wherein the first thin film transistor is a P-type thin film transistor, and the second thin film transistor is an N-type thin film transistor.

20. The liquid crystal display as claimed in claim 17, wherein each stage of the GOA unit circuit further comprises a positive and negative phase scan control module, a latching module, a reset module, and a signal processing module;
the positive and negative phase scan control module comprises two transmission gates; a previous stage transmission signal is inputted into an input terminal of a first transmission gate, a first control terminal is electrically connected with a first control unit, a second control terminal is electrically connected with a second control unit, an output terminal is electrically connected with an input terminal of the latching module; the previous stage transmission signal is inputted into an input terminal of a second transmission gate, a first control terminal is electrically connected with the second control unit, a second control terminal is electrically connected with the first control unit, an output terminal is electrically connected with the input terminal of the latching module;
the latching module comprises two clock control inverters and one of the inverter; a first terminal of a first clock control inverter is electrically connected with an output terminal of the positive and negative phase scan control module, a second terminal is electrically connected with an output terminal of the inverter on the latching module, a first clock signal is inputted into a control terminal, the output terminal is electrically connected with an input terminal of the inverter on the latching module; a second terminal of a second clock control inverter is electrically connected with the output terminal of the positive and negative phase scan control module, a first terminal is electrically connected with the output terminal of the inverter on the latching module, a second clock signal is inputted into a control terminal, the output terminal is electrically connected with the input terminal of the inverter on the latching module;
the reset module comprises a ninth thin film transistor, a reset signal is inputted into a gate of the ninth thin film transistor, a source is grounded, a drain is electrically connected with the input terminal of the inverter on the latching module; and
the signal processing module comprises a NAND gate controller, a first input terminal of the NAND gate controller is electrically connected with the output terminal of the inverter on the latching module, a third clock signal is inputted into a second input terminal, an output terminal is electrically connected with an input terminal of the stage transmission signal buffering module.
